(19) United States
(12) Patent Application Publication
(10) Pub. No.: US 2021/0240209 A1
(43) Pub. Date: Aug. 5, 2021

(54) INLINE FLOW CONTROL SYSTEM WITH PARALLEL FLOW SOLENOID VALVES

(71) Applicant: Hog Slat, Inc., Newton Grove, NC (US)

(72) Inventor: Tyler Clay Marion, Clayton, NC (US)

(21) Appl. No.: 16/778,640

(22) Filed: Jan. 31, 2020

(51) Int. Cl. G05D 9/12; F24F 6/02; F24F 11/84

(52) U.S. Cl. CPC G05D 9/12; F24F 2140/00; F24F 11/84; F24F 6/02

(57) ABSTRACT

Disclosed is an inline flow control system with parallel flow solenoid valves. In particular, in certain embodiments, the flow control system includes a flow control device with switch ports in electrical communication with a high float switch and a low float switch. The flow control device includes a first solenoid valve to control fluid flow through a first fluid pipe based on the high float switch, and a second solenoid valve to control fluid flow through a second fluid pipe based on the low float switch. In certain embodiments, the flow control system includes a manual bypass valve for a third fluid pipe. The fluid pipes are in parallel flow. In certain embodiments, the flow control system is devoid of an electronic controller. Accordingly, the inline flow control system can be retrofitted for existing flow systems with minimal cost and effort.

### FIELD OF THE DISCLOSURE

The disclosure relates to flow control systems, such as for evaporative cooling systems. More particularly, the disclosure relates to an inline flow control system with parallel flow solenoid valves.

### BACKGROUND

An evaporative cooler or cooling system cools air through the evaporation of water. Evaporative cooling systems can be particularly effective for cooling livestock to reduce heat stress and/or production loss. Evaporative cooling is an indirect cooling method that utilizes air entering or within a barn. The barn may be outfitted with evaporative cooling pads that pull air through a media saturated with water. As the water evaporates, it cools and humidifies the air entering the barn. This cool and humidified air then increases convective heat loss from the animals in the barn as compared to utilizing air at ambient conditions.

Thus, evaporative cooling systems include a water supply to provide water to saturate the evaporative cooling pads. A water trough or tank may be employed to store water that is then pumped by a water pump(s) to the evaporative cooling pads for saturation. Proper operation of evaporative cooling systems requires maintaining a minimum water level of the water trough or tank. Some systems to maintain a minimum water level may include sensors and/or processing logic, which may be cost prohibitive in certain applications. Such systems that maintain a minimum water level in the tank or trough may be expensive and/or not easily retrofitted into existing evaporative cooling systems.

No admission is made that any reference cited herein constitutes prior art. Applicant expressly reserves the right to challenge the accuracy and pertinency of any cited documents.

### SUMMARY

Disclosed is an inline flow control system with parallel flow solenoid valves. In particular, in certain embodiments, the flow control system includes a flow control device with switch ports in electrical communication with a high float switch and a low float switch. The flow control device includes a first solenoid valve to control fluid flow through a first fluid pipe based on a received first electrical signal from the high float switch, and a second solenoid valve to control fluid flow through a second fluid pipe based on a received second electrical signal from the low float switch. The first pipe and second pipe are in parallel flow within the flow control device. In certain embodiments, the flow control system includes a manual bypass valve in parallel flow with the solenoid valves. In certain embodiments, the flow control system is devoid of an electronic controller. Accordingly, the inline flow control system can be retrofitted for existing flow systems (e.g., evaporative cooling systems) with minimal cost and effort. Further, the first solenoid valve and the second solenoid valve can be concurrently activated for parallel flow, such as in extreme circumstances requiring greater flow.

One embodiment is directed to a flow control device, including a flow control housing including a fluid inlet, a fluid outlet, a first switch port, and a second switch port. The flow control device further includes a first fluid pipe positioned in the flow control housing and in fluid communication with the fluid inlet and the fluid outlet. The first fluid pipe includes a first solenoid valve configured to control fluid flow through the first fluid pipe. The flow control device further includes a second fluid pipe positioned in the flow control housing and in fluid communication with the fluid inlet and the fluid outlet. The second fluid pipe includes a second solenoid valve configured to control fluid flow through the second fluid pipe. The second fluid pipe is in parallel flow with the first fluid pipe. The first solenoid valve is further configured to control fluid flow through the first fluid pipe based on a received first electrical signal from a first switch via the first switch port. The second solenoid valve is further configured to control fluid flow through the second fluid pipe based on a received second electrical signal from a second switch via the second switch port.

Another embodiment is directed to a flow control system, including a flow control device. The flow control device includes a flow control housing including a fluid inlet, a fluid outlet, a first switch port, and a second switch port. The flow control device further includes a first fluid pipe positioned in the flow control housing and in fluid communication with the fluid inlet and the fluid outlet. The first fluid pipe includes a first solenoid valve configured to control fluid flow through the first fluid pipe. The flow control device further includes a second fluid pipe positioned in the flow control housing and in fluid communication with the fluid inlet and the fluid outlet. The second fluid pipe includes a second solenoid valve configured to control fluid flow through the second fluid pipe. The second fluid pipe is in parallel flow with the first fluid pipe. The flow control system further includes a high float switch in electrical communication with the first solenoid valve via the first switch port. The flow control system further includes a low float switch in electrical communication with the second solenoid valve via the second switch port. The first solenoid valve is further configured to control fluid flow through the first fluid pipe based on a received first electrical signal from the high float switch. The second solenoid valve is further configured to control fluid flow through the second fluid pipe based on a received second electrical signal from the low float switch.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a diagram of a flow control system including a flow control device in fluid communication with a water supply and a liquid container and in electrical communication with a power supply, a low float switch, and a high float switch;

FIG. 1B is a diagram of the flow control system of FIG. 1A illustrating an interior of the flow control device including a first solenoid valve, a second solenoid valve, and a manual bypass valve in parallel flow;

FIG. 2A is a diagram of the flow control system of FIGS. 1A-1B illustrating a high water state wherein the high float switch and the low float switch are in a float orientation with the first solenoid valve and the second solenoid valve in a closed orientation;

FIG. 2B is a diagram of the flow control system of FIG. 2A illustrating a medium water state wherein the high float switch is in a down orientation with the first solenoid valve in an open orientation, and the low float switch is in a float orientation with the second solenoid valve in a closed orientation;

FIG. 2C is a diagram of the flow control system of FIGS. 2A-2B illustrating a low water state wherein the high float switch and the low float switch are in a down orientation with the first solenoid valve and the second solenoid valve in an open orientation;

FIG. 3 is an exploded perspective view of a flow control endcap for a liquid container of the flow control system of FIGS. 1A-1B including the high float switch, the low float switch, and a straight fluid outlet;

FIG. 4 is an exploded perspective view of a flow control assembly for a liquid trough of the flow control system of FIGS. 1A-1B including the high float switch, the low float switch, and a right angle fluid outlet; and

FIG. 5 is a side view of an interior of an electrical junction box of the flow control device of FIGS. 1A-1B.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The embodiments set out below represent the information to enable those skilled in the art to practice the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures. Terms such as “left,” “right,” “top,” “bottom,” “front,” “back,” “horizontal,” “parallel,” “perpendicular,” “vertical,” “lateral,” “coplanar,” and similar terms are used for convenience of describing the attached figures and are not intended to limit this description. For example, terms such as “left side” and “right side” are used with specific reference to the drawings as illustrated and the embodiments may be in other orientations in use. Further, as used herein, terms such as “horizontal,” “parallel,” “perpendicular,” “vertical,” “lateral,” etc., include slight variations that may be present in working examples.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Disclosed is an inline flow control system with parallel flow solenoid valves. In particular, in certain embodiments, the flow control system includes a flow control device with switch ports in electrical communication with a high float switch and a low float switch. The flow control device includes a first solenoid valve to control fluid flow through a first fluid pipe based a received first electrical signal from on the high float switch, and a second solenoid valve to control fluid flow through a second fluid pipe based on a received second electrical signal from the low float switch. The first pipe and second pipe are in parallel flow within the flow control device. In certain embodiments, the flow control system includes a manual bypass valve in parallel flow with the solenoid valves. In certain embodiments, the flow control system is devoid of an electronic controller. Accordingly, the inline flow control system can be retrofitted for existing flow systems (e.g., evaporative cooling systems) with minimal cost and effort. Further, the first solenoid valve and the second solenoid valve can be concurrently activated for parallel flow, such as in extreme circumstances requiring greater flow.

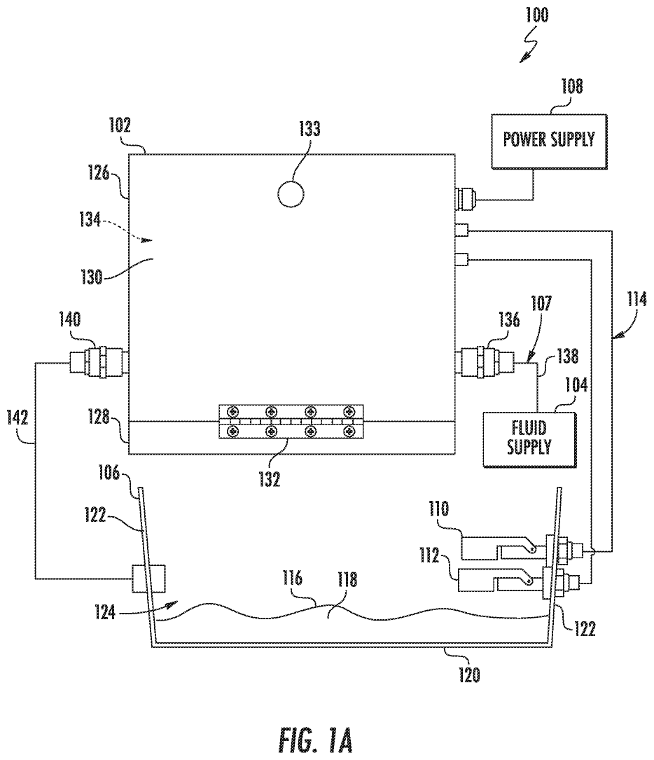

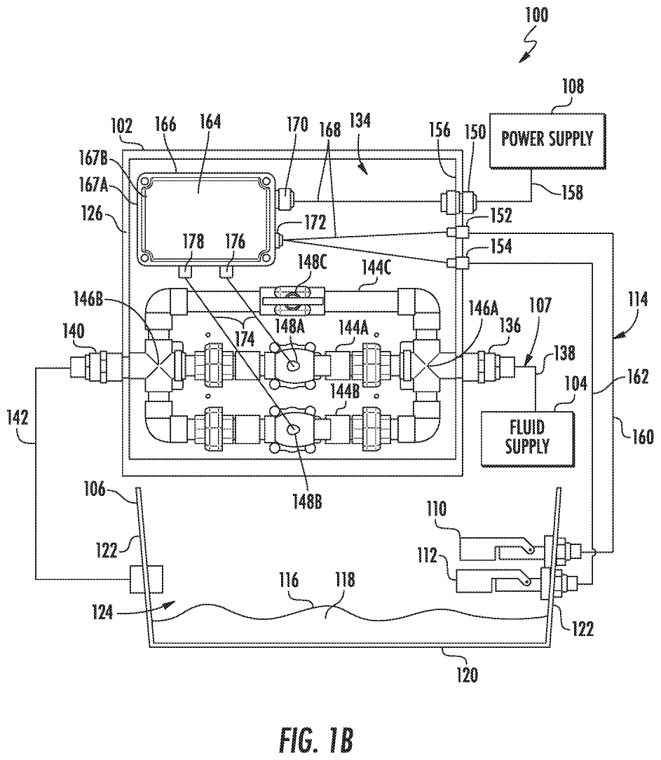

FIGS. 1A-1B are diagrams of a flow control system 100. In particular, FIG. 1A is a diagram of a flow control system 100 including a flow control device 102 in fluid communication with a fluid supply 104 (may also be referred to herein as a fluid source, liquid supply, water supply) and a fluid container 106 (may also be referred to herein as a destination, liquid container, etc.). The flow control device 102 is configured to be placed inline between the fluid supply 104 and the fluid container 106, such as by retrofitting into existing water flow systems or evaporative cooling systems. The flow control device 102 controls the flow of fluid from the fluid supply 104 to the fluid container 106 via external fluid pipes 107 (e.g., without using an electronic controller). The flow control device is in electrical communication with a power supply 108, a high float switch 110, and a low float switch 112 via external electrical wiring 114. The flow control device 102 is configured to control the fluid level 116 of a fluid 118 (e.g., liquid, water, etc.) in the fluid container 106 based on electrical signals received (and/or not received) from the low float switch 112 and/or the high float switch 110.

The fluid container 106 includes at least a bottom wall 120 and sidewalls 122 defining a container interior 124 to hold and/or direct fluid flow of the fluid 118. In certain embodiments, the fluid container 106 includes a reservoir, tank, barrel, vat, trough, etc. configured to hold stagnant and/or flowing fluid 118 (e.g., water), such as for evaporative cooling systems. The high float switch 110 and low float switch 112 are mounted in the sidewall 122 and extend into the container interior 124. In certain embodiments, the high float switch 110 and/or the low float switch 112 are electromagnetic float switches. As explained in more detail below, the high float switch 110 and/or low float switch 112 are activated or deactivated depending on the height of the fluid 118 within the container interior 124. The high float switch 110 is positioned farther from the bottom wall 120 than the low float switch 112. Accordingly, the high float switch 110 and the low float switch 112 are activated or deactivated at differing fluid heights (e.g., liquid heights).

Based on the signals (or lack thereof) from the low float switch 112 and/or the high float switch 110, the flow control device 102 controls the flow of fluid from the fluid supply 104 through the flow control device 102 to the fluid container 106. In certain embodiments, the flow control device 102 is devoid of an electronic controller to reduce costs while also providing flow control functionality. The flow control device 102 can be retrofitted for existing flow systems (e.g., evaporative cooling systems) with minimal cost and effort. Retrofitting is facilitated by the inline installation of the flow control device 102 and/or minimal mounting requirements of the high float switch 110 and/or the low float switch 112.

The flow control device 102 includes a flow control housing 126 with a base 128 and a cover 130 (may also be referred to as a hinged cover) attached to the base 128 by a hinge 132. The base 128 and the cover 130 of the flow control housing 126 define an interior 134. In certain embodiments, the cover 130 includes a cam latch 133 for selectively locking the cover 130 relative to the base 128.

The flow control housing 126 includes a fluid inlet 136 (may also be referred to as a fluid inlet pipe) in fluid communication with (e.g., coupled to) the fluid supply 104 and configured to receive fluid therefrom (e.g., via external upstream fluid pipes 138) and a fluid outlet 140 (may also be referred to as a fluid outlet pipe) in fluid communication with (e.g., coupled to) the fluid container 106 (e.g., via external downstream fluid pipes 142). The flow control device 102 further includes a first fluid pipe 144A, a second fluid pipe 144B, and a third fluid pipe 144C positioned within the interior 134 of the flow control housing 126 and in fluid communication with (e.g., coupled to) the fluid inlet 136 and the fluid outlet 140. The first fluid pipe 144A, the second fluid pipe 144B, and the third fluid pipe 144C are in parallel flow with one another via an upstream junction 146A and a downstream junction 146B.

The first fluid pipe 144A (may also be referred to herein as a first internal fluid pipe, primary flow pipe, high flow pipe, main flow pipe) includes a first solenoid valve 148A configured to control fluid flow through the first fluid pipe 144A. The first solenoid valve 148A is configured to move between a closed position preventing fluid flow and an open position allowing fluid flow.

Solenoid valves provide an advantage over other types of valves in delivering more water faster. For example, mechanical valves (e.g., carrot valves) often deliver water proportional to arm movement. This may create high variability in the exact water level when the water flow turns on and/or off (i.e., turn on and/or off are not consistently accurate). This can be particularly problematic for applications requiring precise and/or shallow water levels (e.g., in certain evaporative cooling systems). In high temperature conditions, mechanical valves may not be able to keep up with the rate of water evaporation due to the proportional flow nature of the mechanical valves. Comparatively, solenoid valves are often binary (not proportional) in their flow, meaning that the solenoid valve is either full on or off. This means that solenoid valves are able to provide higher flow rates to more precisely maintain the desired water level, even in applications requiring precise and/or shallow water levels. This means that in certain applications, less water is required in the trough and/or the trough is able to be filled much faster. Further, the exact water level for when the water flow turns on and/or off is more precise and/or more consistent, with less fluctuation. For example, in an evaporative cooling system, precise water level management prevents flooding evaporative pads while also ensuring a minimum water level to evaporate for cooling purposes.

The first fluid pipe 144A is aligned with the fluid inlet 136 and the fluid outlet 140. Such alignment reduces the length of the fluid path, along with the drag and pressure for improved fluid flow performance (e.g., increased rates). The second fluid pipe 144B (may also be referred to herein as a second internal fluid pipe, secondary flow pipe, low flow pipe, backup flow pipe, etc.) includes a second solenoid valve 148B configured to control fluid flow through the second fluid pipe 144B. The second fluid pipe 144B is offset from the fluid inlet 136 and the fluid outlet 140. The third fluid pipe 144C (may also be referred to herein as a third internal fluid pipe, manual backup flow pipe, etc.) includes a manual bypass valve 148C (e.g., ball valve) configured to control fluid flow through the third fluid pipe 144C. The third fluid pipe 144C is offset from the fluid inlet 136 and the fluid outlet 140. In certain embodiments, the pipes and/or junctions include a plastic material (e.g., polyvinyl chloride (PVC)).

In certain embodiments, the first fluid pipe 144A is positioned between the second fluid pipe 144B and the third fluid pipe 144C and aligned with the fluid inlet 136 and the fluid outlet 140. Alignment with the fluid inlet 136 and fluid outlet 140 and/or positioning between the second fluid pipe 144B and third fluid pipe 144C reduces the length of the secondary fluid paths, along with the drag and pressure for improved fluid flow performance (e.g., increased rates). In other words, for example, a primary flow path positioned between two secondary flow paths is preferred to having a secondary flow path positioned between the primary flow path and another secondary flow path.

The flow control device 102 further includes a device power port 150 (may also be referred to herein as a supply power port), a first switch port 152, and a second switch port 154 mounted in a sidewall 156 of the flow control housing 126. The device power port 150 is in electrical communication with the power supply 108 via external electrical wiring 158. The first switch port 152 (may also be referred to as a high flow switch port, etc.) is in electrical communication with the high float switch 110 via external electrical wire 160. The first solenoid valve 148A is configured to move from the closed position to the open position upon receiving an electrical signal from the first switch port 152. The second switch port 154 (may also be referred to as a low flow switch port, etc.) is in electrical communication with the low float switch 112 via external electrical wires 162. The second solenoid valve 148B is configured to move from the closed position to the open position upon receiving an electrical signal from the second switch port 154.

The flow control device 102 includes a junction box 164 (may also be referred to herein as a control box, power supply box, etc.) positioned within the interior 134 of the flow control housing 126. In certain embodiments, the junction box 164 includes electrical terminals, such as to convert the voltage from the power supply 108 (e.g., from 240V) to a lower voltage (e.g., 12V) and pass the electrical power through the high float switch 110 and/or low float switch 112 to the first solenoid valve 148A and/or the second solenoid valve 148B. In certain embodiments, the high float switch 110 and the low float switch 112 are 12V switches. In certain embodiments, such voltage reduction improves safety of the flow control device 102 (e.g., preventing exposure of a high voltage wire). In this way, the flow control device 102 is controlled by mechanical switches activating electrical components.

In certain embodiments, the junction box 164 includes a watertight junction housing 166 between a base 167A and a cover 167B to protect electrical components within the interior of the junction box 164 from potential contact with fluid or water (e.g., to prevent short circuiting of components or other potential problems). The junction box 164 is in electrical communication with the device power port 150, the first switch port 152, and the second switch port 154 via upstream internal electrical wiring 168. In particular, the junction box 164 includes a junction power port 170 in electrical communication with the device power port 150, and a junction switch port 172 in electrical communication with the first switch port 152 and the second switch port 154. In certain embodiments, the junction box 164 includes multiple junction switch ports (e.g., one for each device switch port).

The junction box 164 is also in electrical communication with the first solenoid valve 148A and the second solenoid valve 148B via downstream internal electrical wiring 174. In particular, the junction box 164 includes a first valve port 176 in electrical communication with the first solenoid valve 148A and a second valve port 178 in electrical communication with the second solenoid valve 148B. Accordingly, the high float switch 110 is in electrical communication with the first solenoid valve 148A via the first switch port 152 and the electrical junction box 164, and the low float switch 112 is in electrical communication with the second solenoid valve 148B via the second switch port 154 and the electrical junction box 164. In other words, the junction box 164 provides electrical communication between the first switch port 152 and the first solenoid valve 148A and between the second switch port 154 and the second solenoid valve 148B.

The first solenoid valve 148A is configured to control fluid flow through the first fluid pipe 144A based on a received first electrical signal from the high float switch 110 (first switch) via the first switch port 152. The second solenoid valve 148B is configured to control fluid flow through the second fluid pipe 144B based on a received second electrical signal from the low float switch 112 (second switch) via the second switch port 154. Thus, the orientation of the first solenoid valve 148A and the second solenoid valve 148B (and the water flow therethrough) is based on the electrical signals (or lack thereof) from the high float switch 110 and the low float switch 112.

In certain embodiments, the flow control device 102 has dimensions in a range of about 5-30 inches by 5-40 inches (including the fluid inlet 136 and fluid outlet 140) by 2-30 inches. In certain embodiments, the flow control device 102 has dimensions of about 14.60 inches by 21.79 inches (including the fluid inlet 136 and fluid outlet 140) by 6.25 inches. In certain embodiments, the flow control device 102 is sold with the high float switch 110 and/or low float switch 112 within the flow control housing 126 for more compact packaging. In this way, a user can remove the high float switch 110 and/or low float switch 112 from the flow control housing 126 for mounting in a fluid container 106.

In certain embodiments, the first solenoid valve 148A and/or second solenoid valve 148B are ASCO RedHat solenoids. In certain embodiments, the high float switch 110 and/or the low float switch 112 are Dwyer float switches. It is noted that should one or more of the first solenoid valve 148A and/or second solenoid valve 148B fail, they may be easily replaced.

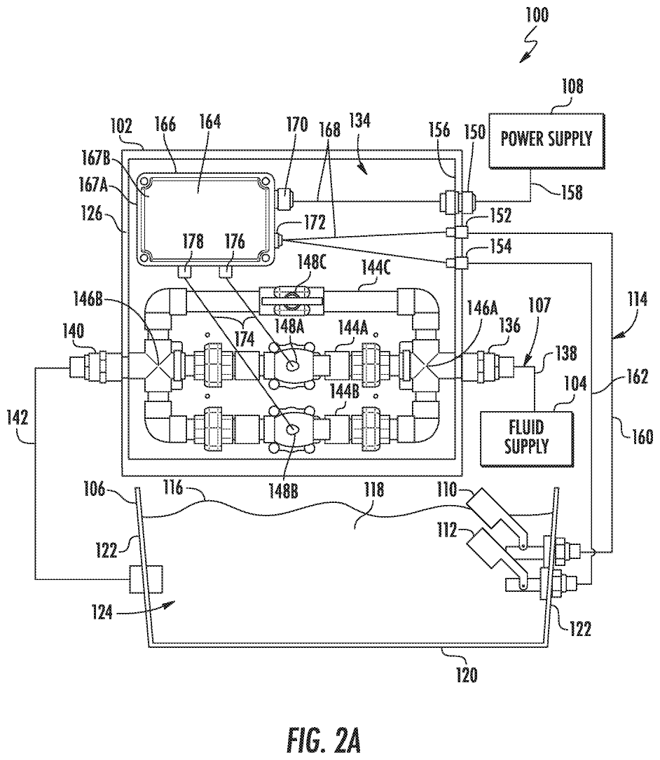

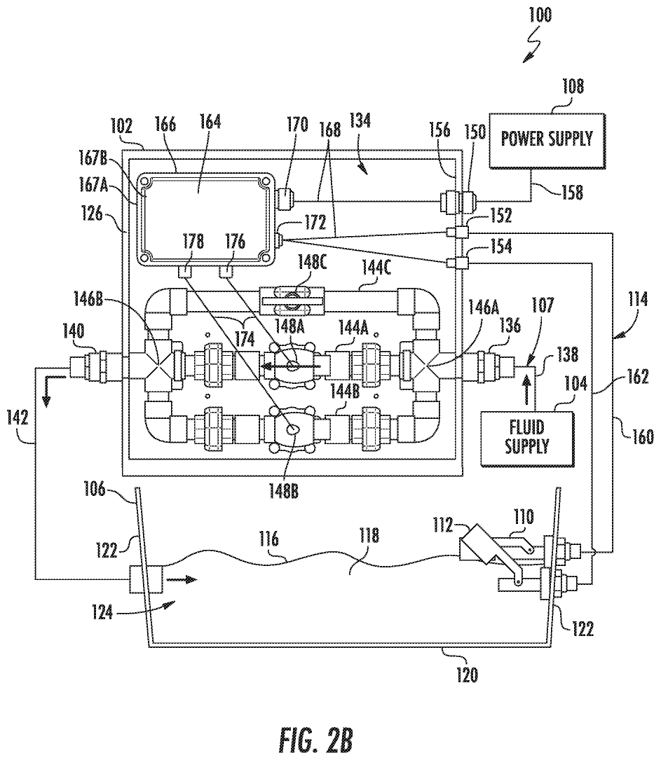

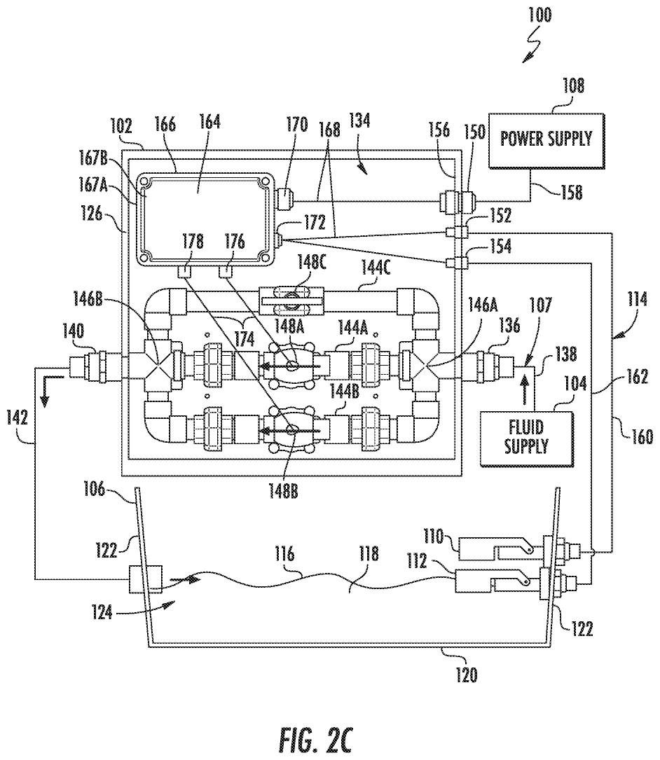

FIGS. 2A-2C are diagrams of the flow control system 100 of FIGS. 1A-1B illustrating various water height states and flow conditions. In particular, FIG. 2A is a diagram of the flow control system illustrating a high fluid state where the high float switch 110 and the low float switch 112 are in a float orientation. In a float orientation, no electrical signal is sent from either of the high float switch 110 or low float switch 112 to the first solenoid valve 148A or the second solenoid valve 148B. As a result, the first solenoid valve 148A and the second solenoid valve 148B are in a closed orientation and no fluid flows through the flow control device 102. Accordingly, no fluid flows from the fluid supply 104 to the fluid container 106.

FIG. 2B is a diagram of the flow control system 100 illustrating a medium fluid state where the high float switch 110 is in a down orientation with the first solenoid valve 148A in an open orientation. As noted above, the low float switch 112 is in a float orientation such that no electrical signal is sent from the low float switch 112 to the second solenoid valve 148B so that no fluid flows through the second solenoid valve 148B. However, in a down orientation, the high float switch 110 transmits an electrical signal to the first solenoid valve 148A. As a result, the first solenoid valve 148A changes from a closed orientation to an open orientation such that fluid flows through the first solenoid valve 148A. In particular, with the first solenoid valve 148A in an open orientation, fluid flows through the first pipe 144A and the flow control device 102 from the fluid supply 104 to the fluid container 106.

FIG. 2C is a diagram of the flow control system 100 illustrating a low fluid state where the high float switch 110 and the low float switch 112 are in a down orientation. As noted above, the high float switch 110 is in a down orientation such that an electrical signal is transmitted from the high float switch 110 to the first solenoid valve 148A such that fluid flows through the first solenoid valve 148A. Similarly, the low float switch 112 is in a down orientation such that an electrical signal is transmitted from the low float switch 112 to the second solenoid valve 148B so that fluid flows through the second solenoid valve 148B. In this way, the low float switch 112 acts as a backup to the high float switch 110 and/or increases the flow if the fluid flow through the first fluid pipe 144A is insufficient. In other words, in certain embodiments, the high float switch 110 and the low float switch 112 do not act as upper and lower bounds for maintaining a water level. Instead, the high float switch 110 acts as a low bound for maintaining a fluid level, with the low float switch 112 providing a backup if the high float switch 110 fails or if the flow through the first fluid pipe 144A is insufficient.

Similarly, the manual bypass valve 148C may be used as a manual backup. In this way, the manual bypass valve 148C may be changed from a closed orientation to an open orientation, such as, for example, in case of an operational failure of the first solenoid valve 148A and/or the second solenoid valve 148B, and/or in case the fluid flow through the first fluid pipe 144A and/or the second fluid pipe 144B is insufficient.

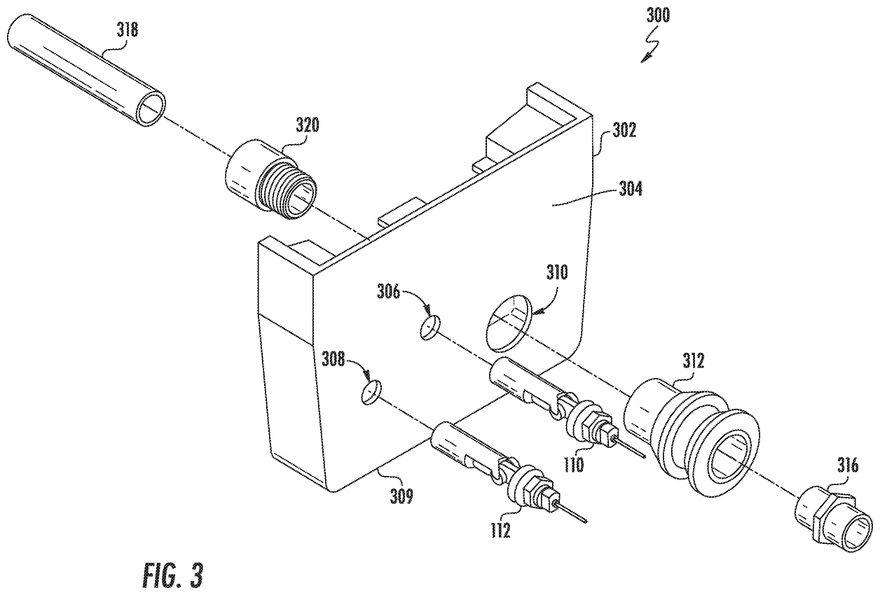

FIG. 3 is an exploded perspective view of a flow control endcap assembly 300 for the fluid container 106 of the flow control system 100. The flow control endcap assembly 300 includes a flow control endcap 302 having an end sidewall 304 with a high float hole 306 and a low float hole 308 for mounting the high float switch 110 and the low float switch 112, respectively. In certain embodiments, the high float switch 110 and the low float switch 112 are mounted through the flow control endcap 302 of the fluid container 106 of an evaporative cooling system. For example, the high float switch 110 and/or the low float switch 112 may include a nut and/or rubber washer, etc. In certain embodiments, the diameters of the high float hole 306 and/or the low float hole 308 are in a range of about 0.1 to 10 inches (e.g., 0.625 inches). In certain embodiments, the high float switch 110 is vertically offset from the low float switch 112 by a range of between 0.1 to 10 inches (e.g., 1 inch). In certain embodiments, the low float switch 110 is vertically offset from a bottom edge 309 of the flow control endcap 302 by a range of between 0.5 to 10 inches (e.g., 2 inches).

In certain embodiments, the high float switch 110 and the low float switch 112 are mounted laterally offset from one another so that the high float switch 110 does not interfere with the float portion of the low float switch 112 (e.g., because the float portion moves vertically). Because the high float switch 110 and the low float switch 112 are merely measuring the fluid height, their lateral location is generally flexible. In certain embodiments, the high float switch 110 is laterally offset from the low float switch 112 by a range of 0.5 to 10 inches (e.g., 2 inches).

The flow control endcap assembly 300 further includes an outlet hole 310 for mounting a bulkhead fitting 312. In certain embodiments, the diameter of the outlet hole 310 is in a range of about 0.5 to 20 inches. The outlet hole 310 has a center positioned beneath a center of the low float hole 308 so that fluid does not interfere with the low float switch 112. In certain embodiments, the bulkhead fitting 312 is mounted through the flow control endcap 302 and in fluid communication with the fluid outlet of the flow control device 102.

In certain embodiments, the flow control endcap assembly 300 includes an external coupler 316 for coupling the bulkhead fitting 312 to external downstream fluid pipes 142 (see FIGS. 1A-2C). In certain embodiments, the flow control endcap assembly 300 includes an internal fluid outlet 318 and an internal coupler 320 for coupling the bulkhead fitting 312 to the internal fluid outlet 318. In certain embodiments, the internal fluid outlet 318 includes a straight fluid outlet and/or a right angle fluid outlet, etc. In certain embodiments, the right angle fluid outlet is directed away from the low float switch 112 and the high float switch 110 to avoid interference therewith.

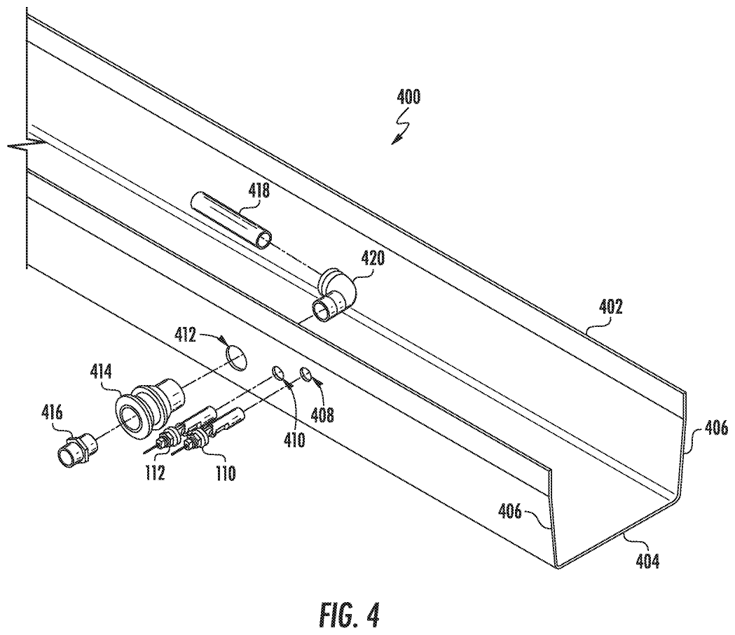

FIG. 4 is an exploded perspective view of a flow control trough assembly 400 for a trough 402 of the flow control system 100. The trough 402 includes a bottom wall 404 and two sidewalls 406. One of the sidewalls 406 includes a high float hole 408 and a low float hole 410 for mounting the high float switch 110 and the low float switch 112, respectively. In certain embodiments, the high float switch 110 and the low float switch 112 are mounted in a trough 402 of a fluid container 106 of an evaporative cooling system. For example, the high float switch 110 and/or the low float switch 112 may include a nut and/or rubber washer, etc. In certain embodiments, the diameters of the high float hole 408 and/or the low float hole 410 are in a range of about 0.1 to 10 inches (e.g., 0.625 inches). In certain embodiments, the high float switch 110 is vertically offset from the low float switch 112 by a range of between 0.1 to 10 inches (e.g., 1 inch). In certain embodiments, the low float switch 110 is vertically offset from the bottom wall 404 of the trough 402 by a range of between 0.5 to 10 inches (e.g., 2 inches).

As similarly noted above, the high float switch 110 and the low float switch 112 are mounted vertically offset from one another. Further, in certain embodiments, the high float switch 110 and the low float switch 112 are mounted laterally offset from one another so that the high float switch 110 does not interfere with the float portion of the low float switch 112.

The trough 402 further includes an outlet hole 412 for mounting a bulkhead fitting 414. In certain embodiments, the diameter of the outlet hole 412 is in a range of about 0.5 to 20 inches. The outlet hole 412 has a center positioned beneath a center of the low float hole 410 so that fluid does not interfere with the low float switch 112. Dimensions for holes sizes and offsets are discussed above.

In certain embodiments, the flow control trough assembly 400 includes an external coupler 416 for coupling the bulkhead fitting 414 to external downstream fluid pipes 142 (see FIGS. 1A-2C). In certain embodiments, the flow control trough assembly 400 includes an internal fluid outlet 418 and an internal coupler 420 for coupling the bulkhead fitting 414 to the internal fluid outlet 418. In certain embodiments, the internal fluid outlet 418 includes a straight fluid outlet and/or a right angle fluid outlet, etc. In certain embodiments, the right angle fluid outlet is directed away from the low float switch 112 and the high float switch 110 to avoid interference therewith.

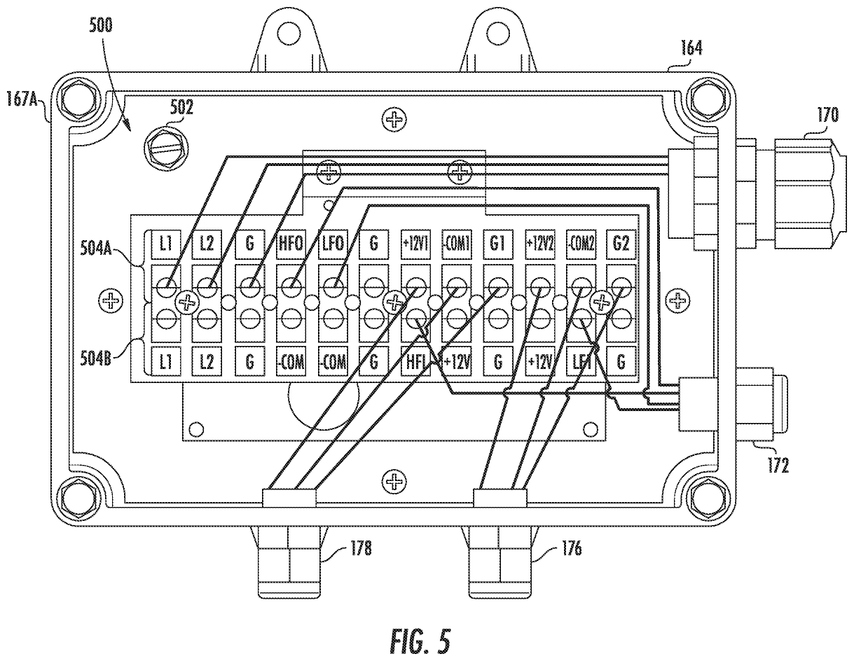

FIG. 5 is a side view of an interior 500 of the electrical junction box 164 of the flow control device 102 of FIGS. 1A-1B. As noted above, in certain embodiments, the electrical junction box 164 is watertight to avoid entry of fluids and potential short circuiting of electrical components (among other potential problems). For example, in certain embodiments, the electrical junction box 164 includes a gasket positioned between a base 167A and a cover 167B (see FIG. 1A). In certain embodiments, the electrical junction box 164 includes a grounding lug 502 and 24 terminals (may also be referred to herein as electrical contacts). In certain embodiments, the 24 terminals are separated into two rows 504A, 504B of 12 terminals. Portions of the terminals are wired, respectively, through the junction power port 170, the junction switch port 172, the first valve port 176, and the second valve port 178, as described above in FIGS. 1A-2C.

It will be apparent to those skilled in the art that various modifications and variations can be made without departing from the spirit or scope of the invention.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A flow control device, comprising:
a flow control housing comprising a fluid inlet, a fluid outlet, a first switch port, and a second switch port;
a first fluid pipe positioned in the flow control housing and in fluid communication with the fluid inlet and the fluid outlet, the first fluid pipe including a first solenoid valve configured to control fluid flow through the first fluid pipe; and
a second fluid pipe positioned in the flow control housing and in fluid communication with the fluid inlet and the fluid outlet, the second fluid pipe including a second solenoid valve configured to control fluid flow through the second fluid pipe, the second fluid pipe in parallel flow with the first fluid pipe;
wherein the first solenoid valve is configured to control fluid flow through the first fluid pipe based on a received first electrical signal from a first switch via the first switch port; and
wherein the second solenoid valve is configured to control fluid flow through the second fluid pipe based on a received second electrical signal from a second switch via the second switch port.

2. The flow control device of claim 1, wherein the first fluid pipe is in line with the fluid inlet and the fluid outlet.

3. The flow control device of claim 1, further comprising a third fluid pipe in fluid communication with the fluid inlet and the fluid outlet, the third fluid pipe including a manual bypass valve configured to control fluid flow through the third fluid pipe, the third fluid pipe in parallel flow with the first fluid pipe.

4. The flow control device of claim 3, wherein the manual bypass valve comprises a ball valve.

5. The flow control device of claim 3, wherein the first fluid pipe is positioned between the second fluid pipe and the third fluid pipe.

6. The flow control device of claim 1, wherein the flow control device is devoid of an electronic controller.

7. The flow control device of claim 1, further comprising a junction box positioned within the flow control housing.

8. The flow control device of claim 7, wherein the junction box comprises a watertight junction housing.

9. The flow control device of claim 8,
wherein the first switch port is in electrical communication with the first solenoid valve via the junction box; and
wherein the second switch port is in electrical communication with the second solenoid valve via the junction box.

10. The flow control device of claim 9, wherein the junction housing comprises a junction switch port in electrical communication with the first switch port and the second switch port.

11. The flow control device of claim 9, wherein the junction box provides electrical communication between a first solenoid port and the first solenoid valve and between a second solenoid port and the second solenoid valve.

12. The flow control device of claim 8,
wherein the flow control housing comprises a device power port; and
wherein the junction housing comprises a junction power port in electrical communication with the device power port.

13. The flow control device of claim 1,
wherein each of the first solenoid valve and the second solenoid valve is configured to move between a closed position preventing fluid flow and an open position allowing fluid flow;
wherein the first solenoid valve is configured to move from the closed position to the open position upon receiving an electrical signal from the first switch port; and
wherein the second solenoid valve is configured to move from the closed position to the open position upon receiving an electrical signal from the second switch port.

14. The flow control device of claim 1, wherein the flow control housing comprises a hinged cover.

15. A flow control system, comprising:
a flow control device comprising:
a flow control housing comprising a fluid inlet, a fluid outlet, a first switch port, and a second switch port;
a first fluid pipe positioned in the flow control housing and in fluid communication with the fluid inlet and the fluid outlet, the first fluid pipe including a first solenoid valve configured to control fluid flow through the first fluid pipe; and
a second fluid pipe positioned in the flow control housing and in fluid communication with the fluid inlet and the fluid outlet, the second fluid pipe including a second solenoid valve configured to control fluid flow through the second fluid pipe, the second fluid pipe in parallel flow with the first fluid pipe;
a high float switch in electrical communication with the first solenoid valve via the first switch port; and
a low float switch in electrical communication with the second solenoid valve via the second switch port;
wherein the first solenoid valve is configured to control fluid flow through the first fluid pipe based on a received first electrical signal from the high float switch; and
wherein the second solenoid valve is configured to control fluid flow through the second fluid pipe based on a received second electrical signal from the low float switch.

16. The flow control system of 15, wherein the high float switch is a high electromagnetic float switch, and the low float switch is a low electromagnetic float switch.

17. The flow control system of claim 15, wherein the high float switch and the low float switch are mounted through an endcap of a fluid container of an evaporative cooling system.

18. The flow control system of claim 17, further comprising a bulkhead fitting mounted through the endcap and in fluid communication with the fluid outlet of the flow control device.

19. The flow control system of claim 15, wherein the high float switch and the low float switch are mounted in a trough of an evaporative cooling system.

20. The flow control system of claim 19, further comprising a bulkhead fitting mounted through the trough and in fluid communication with the fluid outlet of the flow control device.
